(19) United States
(12) Patent Application Publication
(10) Pub. No.: US 2006/0100105 A1
(43) Pub. Date: May 11, 2006

(54) Agents containing carboxylic acid and the use of the same in plant cultivation

(76) Inventors: Reiner Kober, Fussgonheim (DE); Adolf Parg, Bad Durkheim (DE); Jurgen Fries, Ludwigshafen (DE); Hans Ziegler, Mutterstadt (DE)

Correspondence Address: BIRCH STEWART KOLASCH & BIRCH, PO BOX 747, FALLS CHURCH, VA, 22040-0747, US

(21) Appl. No.: 10/525,008

(22) PCT Filed: Aug. 8, 2003
(86) PCT No.: PCT/EP03/08837

§ 371 Date: Sep. 8, 2005

(30) Foreign Application Priority Data
Aug. 19, 2002 (EP) 10237885.1

(51) Int. Cl. A01N 43/84; A01N 43/40; A01N 43/653

(52) U.S. Cl. 504/224; 504/248; 504/272

(57) ABSTRACT

The present invention relates to carboxylic-acid-comprising compositions based on bioregulatory active ingredients from the triazole class and to their use as bioregulator in plant cultivation.

The present invention relates to carboxylic-acid-comprising compositions based on bioregulatory active ingredients from the triazole class and to their use as bioregulators in plant cultivation.

Triazoles are an important class of active ingredients in the field of pesticides. As ergosterol biosynthesis inhibitors, they are primarily employed as fungicides (see, for example, DE 195 20 935 A1). Some triazoles are also used as plant growth regulators. Moreover, various of the actually fungicidally active triazoles are occasionally ascribed plant-growth-regulatory properties (see, for example, EP 0 040 345 A2; EP 0 057 357 A2). Thus, paclobutrazole and uniconazole inhibit gibberellin biosynthesis and thus cell elongation and cell division.

Further bioregulatory active ingredients which are employed in the field of agriculture include, for example, quaternary compounds whose most prominent representatives are N,N,N-trimethyl-N-β-chloroethylammonium chloride (CCC, chlorcholine chloride, chlormequat chloride, DE 12 94 734), N,N-dimethylmorpholinium chloride (DMC, DE 16 42 215) and N,N-dimethylpiperidinium chloride (DPC, MQC, mepiquat chloride, DE 22 07 575). These active ingredients, in particular chlormequat chloride and mepiquat chloride, are typically employed in the cultivation of cereals in relatively high doses. The application rate of these active ingredients per application is, as a rule, 0.3-1.5 kg/ha. The products are commercially available for example as aqueous active ingredient concentrates (for example Cycocel® and Terpal brands (mixtures with ethephon) as SL mixtures, BASF).

The active ingredients from the class of the quaternized ammonium compounds may also be employed together with further bioregulatory active compounds. For example, EP 0 344 533 describes synergistic combinations with growth-regulatory 3,5-dioxo-4-propionylcyclohexanecarboxylic acid derivatives, such as prohexadione-calcium. DE 43 00 452 A1 proposes the use of CCC together with tebuconazole or triadimefon for inhibiting plant growth. The use of uniconazole together with CCC is described in EP 287 787 A1 for regulating the growth of plants.

With a view to industrial production and application of these active ingredients, the development of an effective composition is of particular importance, in addition to the optimization of the characteristics of the active ingredient(s). An appropriate formulation of the active ingredient(s) must ensure an optimal balance between characteristics (in some cases contrary) such as biological activity, toxicology, potential environmental effects and financial outlay. In addition, the formulation plays an important role in determining the shelflife and ease of use of a composition.

As a rule, the active ingredients from the triazole class which have been described at the outset are essentially insoluble in water so that the formulation of suitable aqueous solutions and, in particular, aqueous concentrates, is particularly difficult. For example, these active ingredients tend to recrystallize upon dilution with water in a tank mix. In view of these problems, U.S. Pat. No. 5,968,964 describes certain liquid formulations which yields a mixture of 1-pentanol and 2-methylpentanol for solubilizing triazoles. U.S. Pat. No. 5,385,948 proposes emulsifiable concentrates of active ingredients which are essentially insoluble in water, which concentrates comprise a biodegradable alkoxyalkyl lactam as solvent. The use of amides, in particular N-substituted cyclic alkylamides (N-alkylpyrrolidones) as solvents or cosolvents for triazoles is described in EP-A-311 632. However, the use of such amides is disadvantageous from the toxicological and ecotoxicological angle.

Moreover, it is advantageous to prepare formulations of active ingredients which are as highly concentrated as possible and diluted with the required amount of water shortly prior to use.

However, highly-concentrated active ingredient solutions are a particular problem since, as a rule, different additives must be added to the formulations in order to stabilize them and/or to potentiate their activity. Frequently, the consequence is that the individual additives and/or active ingredients are incompatible with each other so that unstable formulations are obtained which are disadvantageous owing to the occurrence of opacity, precipitation of the additives or active ingredients or poor storage stability.

In the event the total concentration of additives and active ingredients exceeds a certain maximum, further disadvantageous effects are frequently observed, for example phase separation, sedimentation or pronounced opacity. Such an incompatibility of a mixture manifests itself either directly by the development of a two-phase system or, in the long term, brings about a reduced storage stability of the formulations. Under such circumstances it is frequently no longer possible to add to the ready mix all of the desired or required additives, so that the additives must be provided for the user in a separate container. The user then mixes the concentrates with the further additives, dilutes the mixture with water and pours it into the tank or spray tank shortly prior to use. This, however, requires an additional operation. Moreover, safe and optimal use of the crop protection product is not ensured when it is used inadequately and negligently (for example mistakes made during mixing and diluting and the like).

An alternative for the preparation of highly-concentrated solutions consists in using organic solvents instead of water. However, this is not desirable from the ecological angle. For example, WO 96/22020 and DE 44 45 546 describe potentiating oils and esters which are insoluble in water such as, for example, esters of adipic acid, oleic acid or stearic acid, which may be used as tank mix additives for the preparation of O/W (oil-in-water) type formulations. However, the disadvantages of such formulations in the case of the active ingredients mentioned at the outset is that stabilization of the oil phase against separation of the oil/water phase is a problem since suitable thickeners, for example those from the xanthan series, are generally insufficiently active when large amounts of electrolyte are present.

It is an object to provide stable, homogenous, preferably aqueous-based active ingredient formulations which are distinguished by as high as possible an active ingredient content and which permit a simple, safe and efficient use by the user. In particular, it is an object to find formulations which show no negative symptoms and effects with regard to the recrystallization of triazoles, such as metconazole, in the ready mix or else in the tank mix.

We have found that this object is achieved by carboxylic acids which are particularly suitable for formulating solutions of the triazole components which are sparingly soluble per se, such as, for example, metconazole and tebuconazole.

The present invention therefore relates to compositions comprising
(a) at least one active ingredient selected from among (a1) the triazole class, or an agriculturally utilizable salt thereof,
(b) at least one straight-chain or branched saturated or unsaturated aliphatic carboxylic acid,
the molar ratio of component (b) to component (a1) being greater than 1.

Prepared in accordance with the invention are compositions in which the molar ratio of component (b) to component (a1) is greater than 2. Corresponding molar ratios of greater than 4 entail particular advantages.

Suitable in accordance with the invention are straight-chain or branched saturated or unsaturated aliphatic carboxylic acids which are optionally substituted by 1, 2 or 3 radicals which are independently selected among hydroxyl, alkoxy and halogen. The carboxylic acids include firstly relatively short-chain carboxylic acids with preferably 1 to 6 carbon atoms and secondly relatively long-chain carboxylic acids with preferably 7 to 26 carbon atoms, for example the known fatty acids.

Particularly suitable are carboxylic acids of the formula (I)
R³[—CR⁴(R⁵)]ₙ—COOH (I)
where R³, R⁴, R⁵ and n have the following meanings:

R³ is hydrogen, C₁-C₂₅-alkyl, or C₁-C₂₅-alkenyl;

R⁴ is hydrogen, C₁-C₂₅-alkyl, or C₁-C₂₅-alkenyl;

R⁵ is hydrogen, hydroxyl, C₁-C₆-alkoxy or halogen; and

n is 0, 1, 2 or 3, or

R⁴ and R⁵ together with the carbon to which they are bonded form a carbonyl group (keto acids).

If, in the above formula (I), n=2 or 3, the results are 2 or 3, respectively, radicals R⁴ and R⁵ which can be identical or different and independently of one another can assume the abovementioned meanings.

Preferred substituents for R⁵ are hydroxyl and alkoxy.

According to another aspect, it is advantageous to add the carboxylic acids in such an amount that the pH value of the formulation, measured at a concentration of 1% in pure water, ranges from approximately 2.5 to 5 and in particular 3 to 4.5.

Carboxylic acids which may be mentioned in particular are formic acid, acetic acid, trimethylacetic acid, acrylic acid, propionic acid, 2-methylpropionic acid, butyric acid, i-butyric acid, vinylacetic acid, n-valeric acid, 4-methylvaleric acid, 2-ethylvaleric acid, 2-propylvaleric acid, caproic acid, 2-ethylhexanoic acid, 3-propylhex-2-enoic acid, caprylic acid, n-heptanoic acid, capric acid, pelargonic acid, lauric acid, myristic acid, palmitic acid, stearic acid, arachinic acid, behenic acid, lignoceric acid, cerotic acid, linolic acid, arachidonic acid, a-linolenic acid, γ-linolenic acid, eicosapentaenoic acid, docosahexanoic acid, oleic acid, elaidic acid, idonic acid, glyoxylic acid, 1-hydroxypropionic acid, 2-hydroxypropionic acid (lactic acid), 3-hydroxypropionic acid, 3-hydroxybutyric acid, 4-hydroxy-2-methylbutyric acid, 2-hydroxy-2-methylhex-5-enoic acid, 2-allyl-2-hydroxypent-4-enoic acid, hydroxypivalic acid, glucoheptonic acid, xylonic acid, gulonic acid, D-gluconic acid, L-gluconic acid, 2-keto-L-gulonic acid, 3-keto-L-gulonic acid, 2-keto-L-gluconic acid, L-mannonic acid, mannonic acid, glucoheptonic acid, ricinoleic acid, D-glucuronic acid, D-galacturonic acid, fluoroacetic acid, trifluoroacetic acid, chloroacetic acid, bromoacetic acid, iodoacetic acid, dichloroacetic acid, trichloroacetic acid, α-chloropropionic acid, β-chloropropionic acid, 2-chlorobutyric acid, cyanoacetic acid, laevulinic acid, pyruvic acid and abietic acid.

Advantageous among the above-described carboxylic acids are in particular those which are liquid at 25° C. and 1 bar.

The use of carboxylic acids of the formula (I) in which
R³ denotes hydrogen or C₁-C₅-alkyl,
R⁴ denotes hydrogen,
R⁵ denotes hydrogen or hydroxyl and/or
n is 1,
   is particularly advantageous. In accordance with a particular embodiment of the present invention, propionic acid is used and in accordance with a further preferred embodiment of the present invention, lactic acid is used. Furthermore preferred are acetic acid and also glyoxylic acid and oleic acid.

As a rule, component (b) amounts to more than 2.5% by weight, preferably more than 4% by weight and in particular more than 5% by weight of the total weight of the composition. On the other hand, as a rule, component (b) amounts to less than 70% by weight, preferably less than 50% by weight and in particular less than 40% by weight of the total weight of the composition.

Among the active ingredients of the triazole class, those which have a suitable bioregulatory activity, viz. (a11) metconazole, (a12) epoxyconazole, (a13) tebuconazole, (a14) triadimenole, (a15) triadimefon, (a16) cyproconazole, (a17) uniconazole, (a18) paclobutrazole and (a19) ipconazole, may be mentioned in particular. Active ingredients which are preferably used, in particular with regard to the improvement of root growth according to the invention, are (a11) and/or (a13).

Preferred according to the invention is the use of (a11) metconazole, of the formula (II) 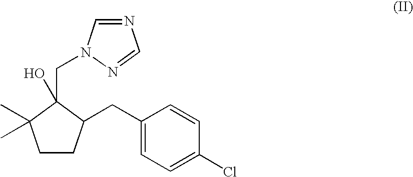
or an agriculturally utilizable salt thereof.

The representation chosen here, of metconazole of the formula (II), includes isomeric forms of this compound. Isomeric forms which must be mentioned in particular are stereoisomers such as enantiomers or diastereoisomers of the formulae (II¹⁻⁴). Apart from the essentially pure isomers, the compounds of the formulae (II) also include their isomer mixtures, for example stereoisomer mixtures. Preferred is a high cis-isomer content, preferably with a cis:trans ratio of 5:1 to 20:1.

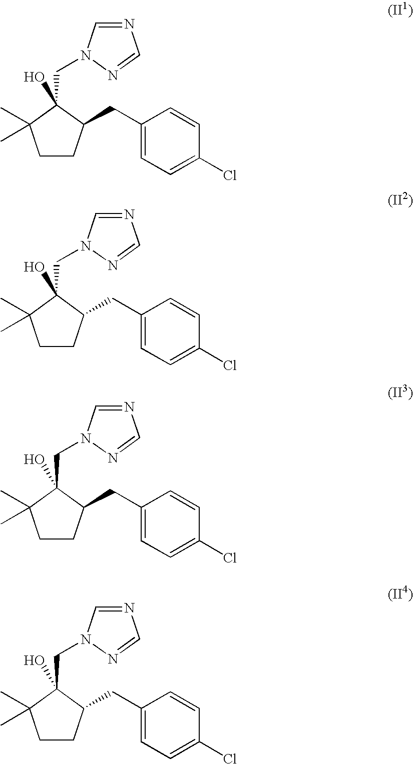

In the present case, the agriculturally utilizable salts of metconazole are preferably acid addition salts.

Anions of useful acid addition salts are mainly chloride, bromide, fluoride, hydrogen sulfate, sulfate, dihydrogen phosphate, hydrogen phosphate, phosphate, nitrate, hexafluorosilicate and hexafluorophosphate.

In accordance with an embodiment of the present invention, the active ingredient component (a) consists essentially of (a1), i.e. an active ingredient from the triazole class. In accordance with a further embodiment, the active ingredient component (a) essentially consists of a compound which is selected from among (a11) to (a19) or of a mixture of two or more of these compounds.

As a rule, component (a1) amounts to more than 1% by weight, preferably more than 2% by weight and in particular more than 2.5% by weight of the total weight of the composition. On the other hand, as a rule, component (a1) amounts to less than 50% by weight, preferably less than 40% by weight and in particular less than 35% by weight of the total weight of the composition.

The combination according to the invention of triazole and carboxylic acid has the advantage of having very good combining ability with aqueous, in particular electrolyte-containing, formulation systems. This permits a coformulation with water or aqueous adjuvants. Further advantages are that liquid preconcentrates of triazole active ingredients are provided which are easy to transport and storage-stable.

In addition to component (a1), the active ingredient component (a) of compositions according to the invention may comprise at least one further active ingredient for plants.

From the aspects of activity and formulation technology, the combination according to the invention, of triazole and carboxylic acid, can advantageously be combined in particular with quaternary ammonium salts. Stable monophase formulations are obtained in combination with selected adjuvants.

In accordance with a preferred embodiment, compositions according to the invention therefore also encompass
(a2) at least one active ingredient of the formula (III) 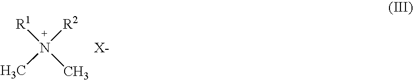
where R¹, R² and X have the following meanings:
R¹ is C₁-C₄-alkyl;
R² is C₁-C₄-alkyl, cyclopentenyl, halogen-C₁-C₆-alkyl, or where R¹ and R² together denote a radical —(CH₂)₅—, —(CH₂)₂—O—(CH₂)₂— or —(CH₂)—CH═CH—(CH₂)—NH—,
X is an anionic group.

Particular active ingredients of the formula (III) result when alkyl is methyl, ethyl or isopropyl. Preferred as the haloalkyl group is the 2-chloroethyl group. If the substituents together with the nitrogen atom to which they are bonded form a cyclic radical, R¹ and R² are preferably a morpholino or piperidino group. X⁻ is, for example, a halide such as bromide and, preferably, chloride, sulfate, an alkyl sulfate, such as methyl sulfate, an alkylsulfonate such as methylsulfonate, a borate such as pentaborate, or another anionic group which is utilizable in agriculture. Divalent anionic groups which are employed in corresponding stoichiometric amounts relative to the ammonium cation are also suitable in principle.

In particular borates, X⁻ represents an anion of the formula (IV)
1/m·[MₓB_{y}O_{z}(A)ᵥ]^{m-}·w (H₂O) (IV)
where

M is a cation of an agriculturally utilizable metal, hydrogen or ammonium,

B is boron,

O is oxygen,

A is a chelating or complexing group which is associated with at least one boron atom or one agriculturally utilizable cation,

x corresponds to a number 0 to 10,

y corresponds to a number 1 to 48,

v corresponds to a number 0 to 24,

z corresponds to a number 0 to 48,

m corresponds to an integer of 1 to 6, and

w corresponds to an integer 0 to 24.

Preferred borates of the formula (IV) are those where

x is zero, or

M is sodium, potassium, magnesium, calcium, zinc, manganese, copper, hydrogen or ammonia, and/or

y corresponds to a number 2 to 20, 2 to 10 or 3 to 10, and/or

m is 1 or 2, and/or

w corresponds to a number 0 to 24.

Especially preferred borates of the formula (IV) are those where

y corresponds to a number 3 to 7, in particular 3 to 5,

z corresponds to a number 6 to 10, in particular 6 to 8,

v is zero, and

w is a number 2 to 10, in particular 2 to 8.

Very especially preferred borates of the formula (IV) are those where y=5; z=8; v=0; m=1; w=2 to 3 (pentaborates).

If appropriate, the borates can be converted at least in part into free borate acid after addition of the carboxylic acid component (b), with the corresponding carboxylates simultaneously resulting from the borates of the formula (III). In such a case it may make sense to employ correspondingly higher molar amounts of carboxylic acids, in particular a molar amount which corresponds to the quaternary ammonium ion of the borates of the formula (III).

If present, chelating and complexing groups A are preferably selected from among hydroxycarboxylic acids, carboxylic acids, alcohols, glycols, aminoalcohols, sugars and similar compounds.

Furthermore, the borates may contain water, for example as water of crystallization in free or coordinated form, or as bound water in the form of hydroxyl groups bonded to the boron.

Further embodiments and also the preparation of borates according to the invention, which is known per se, are described in PCT/EP98/05149.

The active ingredient of the formula (III) is preferably selected among

(a21) N,N,N-trimethyl-N-β-chloroethyl-ammonium salts of the formula (IIIa),

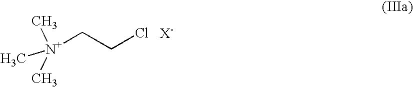

(a22) N,N-dimethylpiperidinium salts of the formula (IIIb)

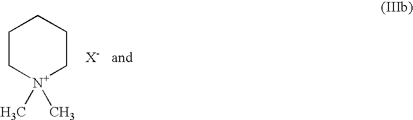

(a23) N,N-dimethylmorpholinium salts of the formula (IIIc) 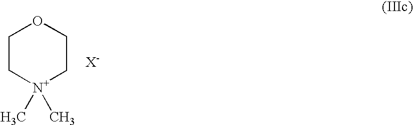
where X⁻ is in particular Cl⁻ or 1/m·[MₓB_{y}O_{z}(A)ᵥ]^{m-}·w (H₂O) with the abovementioned meanings.

Especially preferred are the active ingredient components (a21) and/or (a22), in particular N,N,N-trimethyl-N-β-chloroethylammonium chloride (CCC) or the corresponding pentaborate and N,N-dimethylpiperidinium chloride (MQC) or the corresponding pentaborate.

In accordance with an embodiment of the present invention, the active ingredient component (a2) essentially consists of a compound of the formula (IIIa) or (IIIb) or a mixture of the two compounds.

The relative proportions of active ingredient in combination products are largely variable. In accordance with one aspect, the active ingredient component (a2) is employed in relatively larger amounts by weight than the active ingredient component (a1). This weight ratio of (a2) to (a1) is typically in a range of from 5:1 to 30:1, preferably from 7:1 to 25:1 and in particular from 10:1 to 20:1. This applies in particular to the use of metconazole.

Surprisingly, combinations of the active ingredient components (a1) and (a2), in particular of the active ingredient metconazole with MQC and/or CCC, result in a bioregulatory effect which is superadditive as defined by Colby's formula.

In addition to the active ingredient components (a1) and (a2), the compositions according to the invention may comprise further active ingredients as active ingredient component (a3). These active ingredients may be in particular those whose effect resembles or complements the effect mediated by the active ingredients of components (a1) and/or (a2). Thus, it may be advantageous to employ further bioregulators in addition to the combination of (a1) and (a2), in particular ethephon, prohexadione-calcium or trinexapac-ethyl, but also herbicides, in particular imazaquin, and fungicides. Vitamins, cofactors, trace elements, in particular B, Cu, Co, Fe, Mn, Mo and Zn, minerals, amino acids and other essential nutrients may also be expedient.

The preferred further active ingredient is ethephon (2-chloroethylphosphonic acid). If present, this active ingredient amounts to 5 to 40% by weight as a rule. A further active ingredient for advantageous combinations is trinexapac-ethyl.

In accordance with a particular embodiment of the present invention, the compositions comprise not only the active ingredient components (a1) and (a2), but also the active ingredient component (a3), in particular metconazole, for the formula (II), and chlormequat chloride and/or mepiquat chloride or the corresponding borates of the formulae (IIIa) and (IIIb), respectively, together with ethephon.

As a rule, the compositions according to the invention are fluid, in particular liquid. They are preferably based on an homogeneous phase. In accordance with the invention, homogeneous means in particular uniform distribution of the active ingredient content in the phase. In this sense, the property of homogeneity, which is desirable in accordance with the invention, is reached when misapplications due to inhomogeneities need not be expected when a composition is used in practice. Thus, the homogeneous phase may, in certain cases, also comprise a plurality of phases as long as they are finely distributed within each other. In this context, microphase mixtures may be mentioned in particular. The appearance of the homogeneous phase is preferably clear or transparent, but may also be opaque, show traces of cloudiness or be slightly cloudy or even cloudy. Cloudiness may be the result of, for example, microparticulate auxiliaries, for example silicones or mineral constituents. The viscosities of the phase may also vary within a wide range. Preferably, homogeneous phases according to the invention have low viscosity or are viscous or highly viscous. A flowable homogeneous phase is particularly advantageous. According to this aspect, the apparent viscosities, which can be determined in accordance with OECD Guideline 114 on a Viscolab LC 10 apparatus from Physica or with a Rheomat 115, in a range of approximately 5 mPas to 2000 mPas, preferably from approximately 10 mPas to 500 mPas and in particular approximately 20 mPas to 300 mPas result.

The homogeneous phase comprises at least 2 components (a1) and (b). Such a 2-component system is preferably monophase in accordance with the invention. In accordance with the particular embodiment of the present invention, this also applies to a homogenous phase comprising components (a1), (a2) and (b).

Compositions according to the invention thus come under the group of the liquid formulations. These include, in particular, water-soluble concentrates (SL formulations), suspension concentrates (SC formulations) suspoemulsions (SE formulations) and microemulsions.

In accordance with a particular embodiment, water-soluble concentrates (SL formulations) are prepared. These are based on a homogeneous phase according to the invention which, being a fluid or liquid phase, comprises any further components in dissolved form.

The compositions according to the invention have outstanding stability, thus providing, in particular, great ease of use. Thus, the compositions according to the invention should, under the use conditions, essentially retain a particular state at least over the application period of, as a rule, a few hours. It is particularly advantageous if the phase of the compositions comprising component (a) is homogeneous over at least 5, preferably 8 and in particular 12 hours. Under the stability aspect, particularly preferred compositions are those where no noticeable phase separation of the homogeneous phase is observed in the course of storage for 2 weeks at 54° C. (CIBAC 1-MT46.1.3), storage for 1 week at 0° C. (CIPAC 1-MT39), and/or storage for 2 months at 45° C., or where under certain circumstances, for example at higher temperatures such as the test temperatures, phase separation symptoms occur, but can be rehomogenized by cooling and, if appropriate, expedient agitation of the compositions (reversible phase separation). According to this aspect, preferred among the homogeneous phases with opaque appearance, which show traces of cloudiness or which have a cloudy or slightly cloudy appearance, are those with the above stability characteristics.

In accordance with one embodiment, the present invention relates to compositions comprising large amounts of active ingredient(s) (concentrates). In this case, component (a) generally amounts to more than 100 g/l, preferably more than 200 g/l and in particular more than 250 g/l of the total weight of the composition. On the other hand, component (a) generally expediently amounts to less than 700 g/l, preferably less than 650 g/l and in particular less than 600 g/l of the total weight of the composition. Ranges between 200 and 600 g/l are therefore preferred. In this context, the triazole content usually amounts to up to 300 g/l. The metconazole content, for example, usually amounts to at least 10 g/l, preferably 20-50 g/l.

In accordance with a particular embodiment of the present invention, the compositions comprise, as component (c), at least one surface-active auxiliary. The term “surface-active auxiliary” refers in this case to interface-active or surface-active substances such as surfactants, dispersants, emulsifiers or wetters.

Substances which are useful in principle are anionic, cationic, amphoteric and nonionic surfactants, polymer surfactants and surfactants containing hetero atoms in the hydrophobic group being included.

The anionic surfactants include, for example, carboxylates, in particular alkali metal, alkaline earth metal and ammonium salts of fatty acids, for example potassium stearate, which are usually also referred to as soaps; acylglutamates; sarcosinates, for example sodium lauroylsarcosinate; taurates; methylcelluloses; alkyl phosphates, in particular alkyl monophosphates and alkyl diphosphates; sulfates, in particular those described as component (c2) according to the invention; sulfonates, in particular those described as component (c2) according to the invention; other alkylsulfonates and alkylarylsulfonates, in particular alkali metal, alkaline earth metal and ammonium salts of arylsulfonic acids and alkyl-substituted arylsulfonic acids, alkylbenzenesulfonic acids, such as, for example, lignosulfonic acid and phenolsulfonic acid, naphthalene- and dibutylnaphthalenesulfonic acids, or dodecylbenzenesulfonates, alkyl naphthalenesulfonates, alkylmethyl ester sulfonates, condensates of sulfonated naphthalene and derivatives thereof with formaldehyde, condensates of naphthalenesulfonic acids, phenol and/or phenolsulfonic acids with formaldehyde or with formaldehyde and urea, mono- or dialkylsulfosuccinates; and protein hydrolysates and lignin-sulfite waste liquors. The abovementioned sulfonic acids are advantageously used in the form of their neutral or, if appropriate, basic salts.

The cationic surfactants include, for example, quaternized ammonium salts, in particular alkyltrimethylammonium and dialkydimethylammonium halides, alkyltrimethylammonium and dialkyldimethylammonium alkyl sulfates, and pyridin and imidazolin derivatives, in particular alkylpyridinium halides.

The nonionic surfactants include, in particular,
fatty alcohol polyoxyethylene esters, for example lauryl alcohol polyoxyethylene ether acetate,
alkyl polyoxyethylene ethers and alkyl polyoxypropylene ethers, for example of isotridecyl alcohol and fatty alcohol polyoxyethylene ethers,
alkylaryl alcohol polyoxyethylene ether, for example octylphenyl polyoxyethylene ether,
alkoxylated animal and/or vegetable fats and/or oils, for example maize oil ethoxylates, castor oil ethoxylates, tallow fat ethoxylates,
glycerol esters such as, for example, glycerol monostearate,
fatty alcohol alkoxylates and oxo alcohol alkoxylates, in particular of the type
R²²O—(R¹⁹O)ₓ(R²⁰O)_{y}R²¹ where R¹⁹ and R²⁰ independently of one another=C₂H₄, C₃H₆, C₄H₈ and R²¹═H, or C₁-C₁₂-alkyl, R═C₃-C₃₀-alkyl or C₆-C₃₀-alkenyl, x and y independently of one another equals 0 to 50, but may not both be 0, such as iso-tridecyl alcohol and oleyl alcohol polyoxyethylene ether,
alkylphenyl alkoxylates, such as, for example, ethoxylated isooctylphenyl, octylphenyl or nonylphenyl, tributylphenyl polyoxyethylene ether,
fatty amine alkoxylates, fatty acid amide alkoxylates and fatty acid diethanolamide alkoxylates, in particular their ethoxylates,
sugar surfactants, sorbitol esters such as, for example, sorbitan fatty acid esters (sorbitan monooleate, sorbitan tristearate), ethoxylated carboxylic acids and esters of mono- or polyfunctional alcohols such as polyoxyethylene sorbitan fatty acid esters, alkyl(poly)glycosides, N-alkylgluconamides,
alkylmethyl sulfoxides,
alkyldimethylphosphine oxides, such as, for example, tetradecyldimethylphosphine oxide.

The amphoteric surfactants include, for example, sulfobetaines, carboxybetaines and alkyldimethylamine oxides, for example tetradecyldimethylamine oxide.

The polymeric surfactants include, for example, di-, tri- and multi-block polymers of the type (AB)ₓ, ABA and BAB, for example polystyrene block polyethylene oxide, and AB comb polymers, for example polymethacrylate comb polyethylene oxide and, in particular, ethylene oxide/propylene oxide block copolymers and their end-capped derivatives as they can be found, for example, in Fiedler H. P. Lexikon der Hilfsstoffe für Pharmazie, Kosmetik und angrenzende Gebiete [Dictionaries of the auxiliaries for pharmacology, cosmetics and related fields], Editio Cantor Verlag Aulendorf, 4^{th} edition, 1996, under the keywords “Pluronics”, “Poloxamer”. Preferred in this context are the optionally end-capped ethylene oxide/propylene oxide block copolymers of the formula R¹⁶O—(C₂H₄O)ₚ—(C₃H₆O)_{q}—(C₂H₄O)ᵣ—R¹⁷ or inverse types of the formula R¹⁶O—(C₃H₆O)ₚ—(C₂H₄O)_{q}—(C₃H₆O)ᵣ—R¹⁷, where p, q, r independently of one another correspond to a value in the range of from 2 to 300, preferably from 5 to 200 and in particular from 10 to 150, and R¹⁶ and R¹⁷ independently of one another are hydrogen or C₁-C₄-alkyl, C₁-C₄-alkyl-CO, in particular methyl, t-butyl and acetyl, and further groups which are suitable for end capping. The weight-average molecular weight suitable block copolymer is, as a rule, 500 to 50 000. The block copolymers of this type which are used in practice generally constitute mixtures of various polymer chains whose molecular weight and, in particular, EO/PO distribution varies within certain limits. This is why p, q and r indicate the mean degree of alkoxylation of the molecule section in question. The surface-active characteristics of the EO/PO block copolymer depend on the size and arrangement of the EO and PO blocks. As a rule, the EO block(s) form(s) the hydrophilic moiety of the molecule, while the PO block(s) form(s) the hydrophobic moiety of the molecule. EO/PO block copolymers can be prepared in a manner known per se by the addition of ethylene oxide onto propylene glycols or of propylene oxide onto ethylene glycols. Accordingly, the values of p and r generally agree as the result of this preparation. Moreover, many representatives of such block copolymers and inverse block copolymers are commercially available. EO/PO block copolymers which may be mentioned in this context are, for example, those of the formula (IVa), which are available from BASF as the Pluronic brand, in particular the embodiments L 121 with 10% by weight of EO and a weight-average molecular weight of 4400 and p+r=10; q=68; 10 R 5 with 50% by weight of EO and a weight-average molecular weight of 1950 and p+r=22; q=17; 17 R 5 with 40% by weight of EO and a weight-average molecular weight of 2650 and p+r=24; q=27; 25 R 4 with 40% by weight of EO and a weight-average molecular weight of 3600 and p+r=33; q=37; PE 6400 with 40% by weight of EO and a weight-average molecular weight of 2900 and p+r=26; q=30, PE 6800 with 80% by weight of EO and a weight-average molecular weight of 8000 and p+r=145; q=28; PE 10500 with 50% by weight of EO and a weight-average molecular weight of 6500 and p+r=74; q=56. EO/PO block copolymers are also known under the CTFA name Poloxamer. Poloxamers which are useful in accordance with the invention are mentioned, for example, in H. P. Fiedler: Lexikon der Hilfsstoffe für Pharmazie, Kosmetik und angrenzende Gebiete; Editio Cantor Verlag, Aulendorf, 4^{th} revised and expanded edition (1996) 1203. Others which may be mentioned are the EO/PO block copolymers available from Uniqema/ICI as the Synperonics brand, in particular the PE F, PE L and PE P types, and those available from Clariant as the Genapol brand, in particular Genapol PF 20, 80 and 10 with 20, 80 and 10% by weight of EO, respectively. Others which may be mentioned are the inverse EO/PO block copolymers available from BASF as the Pluronic brand. End-capped EO/PO block copolymers are generally based on the above-described block copolymers. In such end-capped block copolymers, the terminal hydroxyl groups are reacted with suitable groups, preferably etherified or esterified with C₁-C₄-alkyl or alkoyl groups, in particular methyl, t-butyl and acetyl groups.

Further surfactants which may be mentioned by way of example in the present context are perfluoro surfactants, silicone surfactants, phospholipids such as, for example, lecithin or chemically modified lecithins, amino acid surfactants, for example N-lauroylglutamate and surface-active homo- and copolymers, for example polyvinylpyrrolidone, polyacrylic acids in the form of their salts, polyvinyl alcohol, polypropylene oxide, polyethylene oxide, maleic anhydride/isobutene copolymers and vinylpyrrolidone/vinyl acetate copolymers.

Unless specified, the alkyl chains of the abovementioned surfactants are linear or branched radicals which usually have 8 to 20 carbon atoms.

Preferably, the surface-active auxiliary for component (c) is selected from among (c1) alkylglycosides, (c2) alkylsulfonates, alkyl sulfates, alkylarylsulfonates and alkylaryl sulfates, and (c3) quaternized ammonium salts.

The term “alkylglycosides” (frequently also referred to as alkylpolyglycosides, abbreviated to APG) is a collective name for the products which can be obtained by reacting sugars and aliphatic alcohols. As a rule, the sugar component is based on mono-, oligo-, and/or polysaccharides which are composed of one or more identical or different aldoses and/or ketoses, such as glucose, fructose, mannose, galactose, thalose, gulose, allose, altrose, idose, arabinose, xylose, lyxose or ribose. Others which may be mentioned in addition to the monosaccharides which can be derived therefrom, in particular glucose, are, for example, disaccharides, in particular isomaltose and maltose, oligosaccharides, in particular maltotriose and maltotetraose, and oligomeric or polymeric glucose.

In connection with the term “alkylglycosides”, the term “alkyl” generally represents a saturated or unsaturated, branched or unbranched aliphatic radical having 3 to 30 carbon atoms. Unsaturated radicals can be mono- or polyunsaturated and preferably have 1 to 3 double bonds. Alkylglycosides based on longer-chain radicals are frequently also referred to as fatty alkylglycosides. Among these, it is in particular the radicals with at least 8, preferably 8 to 20 and in particular 12 to 18 carbon atoms which are of importance. Alkyl radicals which may be mentioned in particular at this point are those with a suitable number of carbon atoms and which are branched, such as n-octyl, n-nonyl, n-decyl, N-undecyl, n-dodecyl, n-tridecyl, n-tetradecyl, n-hexadecyl and n-octadecyl, or unbranched, such as 2-ethylhexyl, and the alkyl radicals in oxoalcohol mixtures.

The alkylglycosides which are of importance in practice are, as a rule, a mixture of various substances. What varies in the mixture is, in particular, the basic sugar component, especially the degree of polymerization.

Preferred in accordance with the invention are alkylglycosides with a mean degree of polymerization in the range of from 1.0 to 6.0 and in particular 1.1 to 2.0.

Particularly preferred in accordance with the invention are alkylglucosides, i.e. a mixture of monomeric, dimeric, oligomeric and/or polymeric glucose with suitable derivatization. The alkylmonoglucoside takes the form of a mixture of alkyl-α-D- and alkyl-β-D-glucopyranoside and small amounts of the corresponding glucofuranoside. The same applies to the di- oligo- and polyglucosides.

These include, for example, alkylglucosides of the formula VII
R¹⁰O(Z)ₐ
where R¹⁰ is an alkyl radical having 3 to 30, preferably 8 to 18, carbon atoms, Z is a glucose radical and a is a value in the range of from 1 to 6, preferably 1 to 2.

The reaction of sugars with alcohol to prepare the alkylglycosides can be carried out in a manner known per se. Suitable is a reaction with acid catalysis, what is known as a Fischer reaction. Production generally gives rise to aqueous concentrates, for example those with an alkylglucoside content of approximately 50 to 70% by weight. Depending on the preparation process, the concentrates may contain small amounts of unreacted alcohols or fatty alcohols or sugars. Useful processes for the preparation for alkylglucosides are described, for example, in EP 0 635 022 and EP 0 616 611.

A large number of alkylglycosides which are suitable in accordance with the invention is commercially available. Those which may be mentioned are, for example, the products available under the tradenames Agrimul®, PG, APG®, Plantaren® or Glucopon® (all from Henkel), Lutensol® (BASF), Atplus® (ICI Surfactants), Triton® (Union Carbide) or Simulsol®.

Especially preferred in accordance with the invention are the following from among the group of the alkylglucosides:

Alkylglucosides having a 2-ethylhexyl residue and a mean degree of polymerization of 1.6, for example those obtainable under the name AG 6202;

Alkylglucosides having C₁₀-C₁₂-alkyl residues and a mean degree of polymerization of 1.3, for example those obtainable under the name Lutensol® GD70.

Alkyl- and alkylarylsulfonates, alkyl and alkylaryl sulfates for the purposes of the present invention are preferably compounds of the formula (V)
R⁶—(O)_{b}(EO)_{c}SO₃⁻M^{(+,++)} (V),
where R⁶ is an aliphatic group, in particular an alkyl group having 6-24 carbon atoms which can be straight-chain or branched, saturated or mono- or polyunsaturated, or an aromatic group which is optionally mono-, di- or trisubstituted by C₁₋₃₀-alkyl, in particular a phenyl group; b is 0 or 1 (sulfonates or sulfate) and c (degree of ethoxylation) represents an integer from 0 to 50; and M represents a mono- or divalent cationic group, in particular an alkali metal, alkaline earth metal or ammonium cation, for example sodium, potassium, magnesium, calcium or ammonium. Compounds of the formula V for the purposes of the present invention are, for example, alkylsulfonates, fatty alkylsulfonates, alkylarylsulfonates, fatty alkylarylsulfonates, alkyl sulfates, fatty alkylsulfates, or alkylphenyl polyoxyether sulfates. Preferably suitable are selected aliphatic sulfonates, alkylarylsulfonates or alkylphenoxyether sulfates.

Preferred auxiliaries from the group of the alkylsulfonates and alkylarylsulfonates (group (c2) for the purposes of the present invention are for example the following: Wettol®, in particular Wettol® EM 1 (calcium dodecylbenzenesulfonate) or Wettol® EM 11 (calcium alkylarylsulfonate); Emulphor®, in particular Emulphor® OPS 25 (Sodium octylphenol-(EO)₂₅-sulfate); Lutensit® in particular Lutensit® A-E S (sodium isononylphenol tetraethoxysulfate) or Lutensit® A-PS (sodium alkylsulfonate); ALBN 50 (sodium dodecylbenzenesulfonate).

Quarternized ammonium salts for the purposes of the present invention are compounds of the formula (VI) 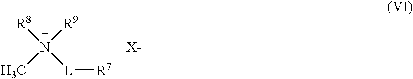
with the following meanings:

R⁷ is C₆-C₂₄-alkyl;

R⁸ Wasserstoff, C₁-C₂₄-alkyl, benzyl, C₁-C₁₂-alkylbenzyl or hydroxypolyethoxyethyl,

R⁹ has the same meaning as R⁸, it being possible for R⁸ and R⁹ to be identical or different,

L is C₁-C₆-alkylene or C₁-C₆-alkyleneaminocarbonyl,

X is an anionic group, for example chloride, sulfate, methosulfate, C₂-C₁₆-alkylsulfonate, C₂-C₁₆-alkylsulfate, phenylsulfonate, naphthylsulfonate, C₁-C₂₄-alkylphenylsulfonate, C₁-C₂₄-alkylnaphthylsulfonate.

The abovementioned longer-chain alkyl groups with 8 or more carbon atoms are also referred to in the literature as fatty alkyl groups. In the definition of R⁸ and R⁹, hydroxypolyethoxyethyl groups are preferably those groups which have a chain length of 0-10 units. In the definition of A, an alkylene group is preferably a methylene, ethylene or propylene group.

Preferred auxiliaries from the group of the quaternized ammonium salts (group c2)) are, for the purposes of the invention, for example the following: Rewoquat®, in particular Rewoquat® CPEM (Cocospentaethoxymethylammonium methosulfate) or Rewoquat® RTM 50 (ricinoleic acid propylamidotrimethylammonium methosulfate); Protecol®, in particular Protecol® KLC 50 (dimethyl-n-alkylbenzylammonium chloride).

Surprisingly, the addition of component (c) leads to a further potentiation of the compositions according to the invention.

Component (c)—if present—generally amounts to 10 to 60% by weight, preferably 15 to 50% by weight and in particular 20 to 45% by weight of the total weight of the composition. Component (c1) is employed in particular in aqueous compositions, where it generally amounts to 2 to 50% by weight, preferably 10 to 40% by weight.

The compositions according to the invention may comprise (d) water. The water acts mainly for dissolving the active ingredient component (a), in particular (a2). Moreover, high water contents favorably affect the homogeneity and flowability of compositions according to the invention. Thus, it may be expedient for the water to amount to more than 10% by weight, preferably more than 20% by weight and in particular more than 25% by weight of the total weight of the composition. However, high water contents may have an unfavorable effect on the sedimentation of solid components, for example in the form of SC components, because the viscosity is reduced. According to this aspect, it is advantageous for the water to amount to less than 60% by weight, preferably less than 50% by weight and in particular less than 45% by weight of the total weight of the composition.

In accordance with a particular embodiment of the present invention, the compositions comprise at least one further auxiliary as component (e).

Component (e) may serve a variety of purposes. Suitable adjuvants will be selected by the skilled worker in the customary manner to meet the requirements.

For example, further adjuvants are selected from among
(e1) minerals and trace elements which can be utilized by plants,
(e2) chelating agents;
(e3) further solvents or diluents.

The minerals and trace elements which can be utilized by plants include, in particular, inorganic ammonium salts such as ammonium sulfate, ammonium nitrate, ammonium chloride, ammonium phosphate, or other minerals or trace elements which can be utilized by plants, in particular ammonium nitrate fertilizer granules and/or urea. They may be incorporated in the compositions according to the invention for example in the form of aqueous concentrates, if appropriate mixed concentrates, such as, for example, Ensol solutions.

Component (e1)—if present—generally amounts to 0.1 to 35% by weight, preferably 0.2 to 20% by weight, of the total weight of the composition.

Preferred chelating agents are compounds which complex heavy metals, in particular transition metals, for example EDTA and its derivatives.

Component (e2)—if present—generally amounts to 0.001 to 0.5% by weight, preferably 0.005 to 0.2% by weight, in particular 0.01 to 0.1% by weight, of the total weight of the composition.

In addition to water, the compositions may comprise further solvents for soluble constituents or diluents for insoluble constituents of the composition.

Examples of substances which are useful in principle are mineral oils, synthetic oils, but also vegetable and animal oils, and low-molecular-weight hydrophilic solvents such as alcohols, ethers, ketones and the like.

Substances which may be mentioned in particular are therefore firstly aprotic or apolar solvents or diluents such as mineral oil fractions of medium to high boiling points, for example kerosene and diesel oil, furthermore coaltar oils, hydrocarbons, liquid paraffins, for example C₈- to C₃₀-hydrocarbons of the n- or iso-alkane series or mixtures of these, optionally hydrogenated or partially hydrogenated aromatics or alkylaromatics from the benzene or naphthalene series, for example aromatic or cycloaliphatic C₇- to C₁₈-hydrocarbon compounds, aliphatic or aromatic carboxylates or dicarboxylates, fats or oils of vegetable or animal origin, such as mono-, di- and triglycerides, in pure form or in the form of a mixture, for example in the form of oily extracts of natural substances, for example olive oil, soya oil, sunflower oil, castor oil, sesame seed oil, corn oil, peanut oil, rapeseed oil, linseed oil, almond oil, safflower oil, and their raffination products, for example hydrogenated or partially hydrogenated products thereof, and/or their esters, in particular methyl and ethyl esters.

Examples of C₈- to C₃₀-hydrocarbons of the n- or iso-alkane series are n- and isooctane, -decane, -hexadecane, -octadecane, -eicosane, and preferably hydrocarbon mixtures such as liquid paraffin (which, in technical-grade purity, may comprise up to 5% of aromatics) and a C₁₈-C₂₄ mixture which is commercially available from Texaco under the name Spraytex oil.

The aromatic or cycloaliphatic C₇- to C₁₈-hydrocarbon compounds include, in particular, aromatic or cycloaliphatic solvents from the series of the alkyl aromatics. These compounds may be unhydrogenated, partially hydrogenated or completely hydrogenated. Such solvents include, in particular, mono-, di- or trialkylbenzenes, mono- di- or trialkyl-substituted tetralins and/or mono-, di-, tri- or tetralkyl-substituted naphthalenes (with alkyl preferably representing C₁-C₆-alkyl). Examples of such solvents are toluene, o-, m- and p-xylene, ethylbenzene, isopropylbenzene, tert-butylbenzene and mixtures, like the products from Exxon sold under the names Shellsol and Solvesso, for example Solvesso 100, 150 and 200.

Examples of suitable monocarboxylic esters are oleic esters, in particular methyl oleate and ethyl oleate, lauric esters, in particular 2-ethylhexyl laurate, octyl laurate and isopropyl laurate, isopropyl myristate, palmitic esters, in particular 2-ethylhexyl palmitate and isopropyl palmitate, stearic esters, in particular n-butyl stearate and 2-ethylhexyl 2-ethylhexanoate.

Examples of suitable dicarboxylic esters are adipic esters, in particular dimethyl adipate, di-n-butyl adipate, di-n-octyl adipate, di-iso-octyl adipate, also referred to as bis(2-ethylhexyl) adipate, di-n-nonyl adipate, di-iso-nonyl adipate and ditridecyl adipate; succinic esters, in particular di-n-octyl succinate and di-iso-octyl succinate, and di(iso-nonyl) cyclohexane-1,2-dicarboxylate.

The above-described aprotic solvents or diluents generally amount to less than 30% by weight, preferably less than 20% by weight and in particular less than 5% by weight of the total weight of the composition.

Some of these aprotic solvents or diluents have adjuvant properties, that is to say in particular potentiating properties. This applies in particular to said mono- and dicarboxylic acids. In view of this, such adjuvants may be admixed with the compositions according to the invention as part of a further formulation (stand-alone product) at a convenient point in time, generally shortly before application.

On the other hand, protic or polar solvents or diluents may be mentioned, for example C₂-C₈-monoalcohols such as ethanol, propanol, isopropanol, butanol, isobutanol, tert-butanol, cyclohexanol and 2-ethylhexanol, C₃-C₈-ketones such as diethyl ketone, t-butyl methyl ketone and cyclohexanone, and also aprotic amines such as N-methyl- and N-octylpyrrolidone.

The percentage of the above-described protic or polar solvents or diluents of the total weight of the composition is kept low in accordance with the invention and generally amounts to less than 20% by weight, preferably less than 15% by weight and in particular less than 10% by weight.

Anti-settling agents may also be used, in particular for suspension concentrates. They serve mainly for rheological stabilization purposes. Substances which may be mentioned in this context are mineral products, for example bentonites, talcites and herktorites.

Further additions which may be useful can be found for example among the mineral salt solutions which are employed for alleviating nutritional and trace element deficiencies, nonphytotoxic oils and oil concentrates, antidrift reagents, antifoams, in particular those of the silicone type, for example Silicon SL, which is available from Wacker, and the like.

In accordance with a particular embodiment, the present invention elates to compositions comprising
(a1) 2 to 35% by weight of at least one active ingredient selected among active ingredients from the triazole class, preferably (a11) metconazole and/or (a12) tebuconazole, or of a salt of these which can be used in agriculture;
(a2) 20 to 25% by weight of at least one active ingredient of the formula (III), preferably (a21) N,N,N-trimethyl-N-β-chloroethylammonium chloride, of the formula (IIIa), and (a22) N,N-dimethylpiperidinium chloride, of the formula (IIIb), or of the corresponding borates;
(b) 5 to 40% by weight of at least one carboxylic acid of the formula (I), preferably propionic acid and/or lactic acid; and, advantageously,
(c) 15 to 45% by weight of a surface-active adjuvant which is selected from among (c1) alkylglucosides, (c2) alkylsulfonates, alkyl sulfates, alkylarylsulfonates and alkylaryl sulfates and (c3) quaternary ammonium salts.

A particular embodiment of these compositions are aqueous compositions which preferably comprise 20 to 45% by weight of water (component d).

In addition, these compositions may comprise further adjuvants, preferably up to 20% by weight and in particular up to 10% by weight.

Compositions according to the invention can be prepared in a manner known per se. At least some of the components are combined. Care must be taken that products, in particular commercially available products, can be used, and their constituents may contribute to various components. For example, a specific surfactant may be dissolved in an-aprotic solvent so that this product can contribute to components (c) and (e) according to the invention. Furthermore, small amounts of undesired substances, for example the abovementioned protic or polar solvents and diluents, may be introduced together with commercially available products. The products which have been combined and now form a mixture are then generally to be mixed intimately with each other to give a homogeneous mixture and, if required—for example in the case of suspensions, milled.

For example, aqueous active ingredient solutions of the quaternary active ingredients of the formula III may initially be introduced into the reaction vessel at a concentration of 50 to 80% by weight and the adjuvants can then be incorporated with stirring. The mixture can subsequently be treated with a concentrate of a triazole such as, for example, metconazole, in a carboxylic acid, for example in propionic acid or lactic acid. As an alternative, it is possible first to dissolve the triazole active ingredient in the carboxylic acid and initially to introduce this mixture into the reaction vessel.

Assuming that, upon dissolution in the carboxylic acids, the weakly basic substructures of the heterocyclic triazole rings of the active ingredients of component (a1) are first converted into onium compounds, which are generally crystalline compounds and are redissolved only when more carboxylic acid is added, it would be advantageous from the process engineering angle initially to introduce the carboxylic acids into the reaction vessel and then to add, or stir in, the solid triazole active ingredients.

Mixing can be carried out in a manner known per se, for example by homogenization using suitable devices such as KPG or magnetic stirrers.

The present invention also relates to the use of compositions according to the invention as bioregulators in a series of different applications, for example in crop production, such as in agriculture and horticulture.

Bioregulatory active ingredients may have an effect on, for example, plant growth (growth regulators).

An example of a bioregulatory application is influencing the longitudinal growth of the plant above ground (growth-regulatory). This may have an effect at virtually all development stages of the plant.

Thus, for example, the vegetative shoot growth of the plants may be inhibited greatly, which manifests itself in particular in reduced longitudinal growth. Accordingly, the treated plants are stunted; moreover, their leaves are darker in color. Advantageous for practical purposes is a reduced growth intensity of grasses at verges, hedges, canal embankments and on lawns such as in parks, sports facilities and orchards, ornamental lawns and airports, so that grass cutting, which involves a great outlay in terms of labor and finance, can be reduced. More compact growth is also desirable in a large number of ornamental species.

Also of economical interest is increasing the standing ability of crops which are susceptible to lodging, such as cereals, maize, oilseed rape and sunflowers. The shortening and strengthening of the shoot axis which this entails reduces or eliminates the danger of the plants “lodging” (breaking) under adverse weather conditions prior to harvest. Also important is the growth-regulatory application for inhibiting the longitudinal growth and for modifying the course of ripening in cotton in the course of time. This enables this crop plant to be harvested exclusively with machines. In fruit trees and other trees, pruning costs may be reduced by growth regulation. At the same time, a more advantageous ratio between vegetative growth and fruit development is achieved. Also, biennial bearing of fruit trees can be interrupted by growth regulation. The use as growth regulators may also increase, or inhibit, lateral branching of the plants. This is of interest when the development of side shoots is to be inhibited in favor of foliar growth, for example in the case of tobacco plants.

Also, frost resistance, for example in winter oilseed rape, can be increased substantially by means of growth regulation. After sowing and before the winter frosts start, the young rapeseed plants are held back in their vegetative development despite favorable growth conditions. The longitudinal growth, and the development of too lush a leaf or plant biomass (which is therefore particularly susceptible to frost) are inhibited. This also reduces the susceptibility to frost of those plants whose floral inhibition tends to be broken prematurely and whose transition into the generative phase is premature. Good tillering in autumn owing to treatment with growth regulators, while avoiding unduly lush growth as winter arrives, is also advantageous in other crops, for example winter cereals. It is thus possible to prevent increased sensitivity to frost and—owing to the fact that the leaf or plant biomass is relatively small—attack by various diseases (for example fungal disease). Moreover, inhibiting the vegetative growth makes possible a higher planting density in a large number of crop plants so that higher yields per unit area can be obtained.

Moreover, growth regulation permits higher yields of plant parts and plant constituents to be obtained. Thus, it is possible for example to induce the growth of larger quantities of buds, flowers, leaves, fruits, seed kernels, roots and tubers, to increase the sugar content in sugarbeet, sugarcane and citrus fruit, to increase the protein content in cereals or soya or to stimulate increased latex flow in rubber trees. In this context, the active ingredients may bring about increased yields by engaging in the plants' metabolism or by promoting or inhibiting the vegetative and/or generative growth. Finally, both shortened or extended development stages and more rapid or delayed maturation of the harvested plant parts before or after harvesting may be achieved by regulating the growth of the plants.

Aspects which are of economic interest are, for example, facilitated harvesting, which is made possible by the dehiscence of fruit, or the reduction of their adherence to the plant, which is concentrated over a period of time, for example, citrus fruit, olives or other varieties and species of stone fruit, pome fruit and hard-shelled fruit. The same mechanism, i.e. the promotion of the formation of abscission tissue between fruit or leaf and shoot part of the plant, is also responsible for the ready controlled defoliation of useful plants such as, for example, cotton.

Moreover, the water consumption of plants may be reduced by means of growth regulation. This is particularly important for land under agricultural cultivation which must be irrigated artificially, which entails high costs, for example in arid or semiarid regions. The use of growth regulators can reduce irrigation intensity and thus lead to more economical crop management. The influence of growth regulators may entail better utilization of water present since, inter alia, the degree of opening of the stomata is reduced, thicker epidermis and cuticula are formed, root penetration of the soil is improved, the transpiring leaf surface area is reduced, or the microclimate in the stand of the crop plants is affected favorably by more compact growth.

The use according to the invention is particularly important for ornamentals, especially for fruit trees and in particular for oilseed rape.

The use according to the invention of the active ingredient combination (a1) and (a2) as bioregulators has advantages over the individual active ingredients in a series of different possible applications in crop production, both in agriculture and in horticulture. In particular, the application rates of individual active ingredients which are required for bioregulatory purposes may be reduced when carrying out a combined application in accordance with the invention. Thus, when using the individual components for specific biological effects, the application rates required may be reduced by more than 20%, advantageously more than 30% and in particular by more than 40%. For example, the application rate of active ingredients of the formula (III) may be set according to the invention at less than 500 g and preferably less than 350 g per ha, and the application rate of metconazole of the formula (II), or agriculturally utilizable salts thereof, to less than 100 g, preferably less than 50 g and in particular less than 30 g per ha. In addition, advantageous, specifically selected additions of adjuvants frequently provide better biological properties than the total of the effects of the individual components when using the tank mix method.

In particular, the present invention relates to the use of at least one bioregulatory active ingredient from the triazole class in combination with at least one active ingredient of the formula (III) as bioregulator for improving root growth. The purpose of this application is mainly the development of an increased number of individual roots, longer roots and/or a greater root surface area. This improves the ability of the plants to take up water nutrients. This is advantageous in particular in the case of light, for example sandy, soils and/or when there is a lack of precipitation. During autumn, a larger storage root is developed, in particular in the case of winter oilseed rape, which allows for more intense growth when spring arrives. In spring, the improved root system provides better anchorage of the shoot in the ground, so that the plants have a markedly improved standing ability. In other plants, the storage root represents all or most of the plant organ to be harvested (for example other Brassicas such as winter and summer radishes, but also sugarbeet, carrots or chicory).

Improved root growth is of particular advantage when accompanied by reduced vegetative growth, that is to say in particular by reduced shoot elongation (shortening) and/or reduced leaf or plant biomass. Accordingly, the present invention preferably relates to reducing the shoot biomass/root biomass ratio.

This application, which relates to root development, is carried out in particular in the production of cereals, for example for wheat, barley, oats and rye, but also maize and rice, very particularly for plants which develop storage roots, such as Brassicas, for example winter and summer radish, mainly oilseed rape and in particular winter oilseed rape, and sugarbeet, carrots or chicory. An aspect which must be mentioned in particular in this context is oilseed rape production, where improved root growth has particularly pronounced effects. This application, which relates to root development, may gain particular importance in practice under certain circumstances, for example in the case of relatively dry soils and/or during the phase in which the plant develops its root system. Particular advantages result by the improved root growth when combined with reduced shoot elongation.

For treatment purposes, the use according to the invention of the above-described active ingredients comprises a method. Here, an effective amount of active ingredient component (a1) and, if appropriate, an effective amount of active ingredient component (a2), generally formulated to suit agricultural practice, is applied to the area under cultivation which is to be treated. Preferably, the active ingredient components are supplied to the plant via a foliar spray. In principle, the application rate may be varied within wide limits owing to the high degree of plant compatibility. Typically, the application rates amount to 0.3-3 l per ha, in particular 0.5-2.0 l/ha.

Sprayable mixtures normally comprise 0.0001 to 10, preferably 0.001 to 5, in particular 0.002 to 2.0,% by weight of active ingredient component (a). To prepare a customary spray mixture, for example 0.2 to 5.0, preferably 0.3 to 3.0, in particular 0.35 to 2.0 l of an active ingredient concentrate according to the invention which comprises component (a) can be diluted with water to 10 to 2000 l, preferably 50 to 1500 l, in particular 100 to 1000 l. If appropriate, 0.1% by weight to 5% by weight (based on the spray mixture) of further anionic, cationic or nonionic surfactants, adjuvants, polymers and/or further active ingredients may be added to the spray mixture. Examples of substances for such surfactants and further adjuvants are described hereinbelow. Starch and starch derivatives, for example a starch containing carboxyl and sulfonyl groups (Nu-Film, from Union Carbide Corp.) and spreaders and extenders such as Vapor Guard from Miller Chemical & Fertilizer Corp., may be mentioned in particular. A particular advantage of the compositions according to the invention is that further tank mix additives, in particular those mentioned above, can be dispensed with when preparing and applying the spray mixture.

The compositions can be applied in the manner known per se, for example by spraying the spray mixtures from a mobile sprayer using nozzles with ultrafine distribution. The apparatuses and techniques which are customary for this purpose are known to the skilled worker.

Within the present description, quantities generally refer to the total weight of the composition unless otherwise specified. In accordance with the invention, the term “essentially” generally refers to a percentage ratio of at least 90%, preferably at least 95%, in particular at least 98%.

For the purposes of the present invention, terms such as alkyl, alkoxy and the like encompass straight-chain or branched hydrocarbon groups such as methyl, ethyl, n-propyl, i-propyl, n-butyl, i-butyl, sec-butyl, t-butyl, n-pentyl, n-hexyl, n-octyl, 2-ethylhexyl, n-nonyl, iso-nonyl, n-decyl, iso-decyl, n-undecyl, iso-undecyl, n-dodecyl, iso-dodecyl, n-tridecyl, iso-tridecyl, stearyl, n-eicosyl, preferably—unless otherwise specified—with 1 to 25, in particular 1 to 6 and especially preferably 1 to 4 carbon atoms.

The term “alkenyl” refers to straight-chain or branched mono-, di-, tri-, tetra- penta- or hexaunsaturated hydrocarbon groups, preferably—unless otherwise specified—with 1 to 25, in particular 1 to 6 and especially preferably 1 to 4 carbon atoms. Radicals which must be mentioned in particular in this context are those of mono- or polyunsaturated fatty acids.

The term “halogen” preferably relates to fluorine, chlorine, bromine and iodine, in particular fluorine and especially chlorine.

The invention is illustrated in greater detail by the examples which follow:

### REFERENCE EXAMPLE 1

### Dissolution Characteristics

The following experimental series describes the dissolution experiments and the advantageous use of carboxylic acids as solvents for triazoles in comparison with other solvents.

TABLE 1
Solubility of triazoles in selected adjuvants

| | Solubility of triazoles [%] at 20° C. | | | |
|---|---|---|---|---|
| | Epoxy | | | Epoxic./Metc. |
| Solvent | conazole | Metconazole | Tebuconazole | in 10:6 mixture |
| Aromatic 200 | 3.8 | 7.6 | | |
| Solvesso 150 | 2.1 | 3.2 | | |
| Propionic acid | 39.5 | >30 | 57.2 | 21.9 |
| Lactic acid | 11.4 | | | |
| Acetic acid | | | 62.2 | |
| NOP | 11.4 | 38.16 | | |
| NMP | 22.6 | 49.7 | | |
| Lactic acid:Lutensol | | 31.4 | | |
| ON 70 2:1 | | | | |
| NOP:Lutensol | | 34.9 | | |
| ON 70 2:1 | | | | |
| g-Butyrolactone:Lutensol ON | | 26.5 | | |
| 70 2:1 | | | | |

In the case of epoxiconazole and other triazoles, propionic acid shows similar or markedly better dissolving properties than NMP, NOP or γ-butyrolactone. The same applies analogously in combination with surface-active adjuvants from the alcohol oligoethoxylates and alcohol polyethoxylate series.

### PREPARATION EXAMPLES

### REFERENCE EXAMPLE 2

### Formulations

The tank mixers employed in Example 1 are prepared by mixing an emulsion concentrate with a metconazole content of 90 g/l and an aqueous concentrate with mepiquat chloride content of 600 g/l using a magnetic stirrer (experiment T1).

The readymixes F1 to F15 are prepared by adding the triazoles to the carboxylic acid with heating to 40-60° C. in order to accelerate dissolution. The nonaqueous adjuvants or active ingredients are subsequently added, followed, if appropriate, by the aqueous adjuvants or active ingredients.

Finally, the mixtures are homogenized by stirring for 2 hours at room temperature. Typical batch sizes are 20 to 100 g of readymix.

MQC and CCC are each employed as aqueous preconcentrate (MQC content 600 g/l, CCC content 750 g/l). Unless otherwise specified, these active ingredients are converted to 100% by weight in the table which follows, while the water contents of the preconcentrates were included in the total amount of water.

TABLE 2
Active ingredients and adjuvants of certain SL
formulations, indicated as [“name”/“g/l”], unless otherwise
indicated, remainder to 1 l: water

Component

| Ex. | (a1) | (a2) | (b) | (c) |
|---|---|---|---|---|
| F1 | Met/21 | MQC/300 | Prop/70 | AG6202/240 |
| | | | | Lutensol ON70/160 |
| F2 | Met/21 | MQC/300 | Prop/70 | AG6202/160 |
| | | | | HOE S4212/240 |
| F3 | Met/21 | MQC/300 | Prop/70 | AG6202/240 |
| | | | | Wettol EM 11/160 |
| F4 | Met/21 | MQC/300 | Prop/70 | Rew UTM/200 |
| | | | | Emulgon EL20/100 |
| | | | | Pluronic PE 9200/100 |

TABLE 3
Active ingredients and adjuvants of certain SL
formulations, indicated as [“name”/“% by weight”], unless
otherwise indicated, remainder to 1 l: water

| | Component | | | | |
|---|---|---|---|---|---|
| Ex | (a1) | (a2) | (b) | (c) | Others |
| F5 | Met/4.36 | — | Prop/12.96 | AG6202/44.44 | Silicon |
| | | | | Lutensol | SL/0.09 |
| | | | | ON70/4.63 | |
| | | | | Wettol | |
| | | | | EM11/29.62 | |
| F6 | Met/4.36 | — | Prop/14.54 | Lutensol | Silicon |
| | | | | TO8/33.93 | SL/0.097 |
| | | | | Benzyl alcohol/ | |
| | | | | 8.73 | |
| | | | | Rhenalyd | |
| | | | | WL922/9.7 | |
| F7 | Met/4.36 | — | Prop/14.53 | Lutensol | Silicon |
| | | | | TO8/33.9 | SL/0.097 |
| | | | | Benzyl alcohol/ | |
| | | | | 8.72 | |
| | | | | Rhenalyd | |
| | | | | WL922/9.69 | |
| F8 | Met/5 | — | Prop/10 | Lutensol | Solvesso |
| | Epox/10 | | | AP10/20 | 200/55 |
| F9 | Met/5 | — | — | Lutensol | Solvesso |
| | Epox/10 | | | AP10/30 | 200/55 |
| F10 | Tebu/6.5 | CCC/30 | Prop/27.3 | Lutensol | |
| | | | | ON30/18.18 | |
| F11 | Tebu/6.5 | CCC/30 | Prop/27.3 | Lutensol | |
| | | | | ON70/18.18 | |
| F12 | Tebu/6.5 | CCC/30 | — | Lutensol | Benzyl |
| | | | | ON30/18.18 | alcohol/27.3 |
| F13 | Tebu/6.5 | CCC/30 | — | Lutensol | Benzyl |
| | | | | ON70/18.18 | alcohol/27.3 |
| F14 | Met/2.8 | MQC/ | — | AG6202/23.3 | NaOH/1.21 |
| | | 25.2 | | Lutensol A- | |
| | | | | LBS/9.3 | |
| | | | | Lutensol | |
| | | | | A3N/9.3 | |
| F15 | Met/2.8 | MQC/ | — | AG6202/23.3 | NaOH/1.21 |
| | | 25.2 | | Lutensol A- | |
| | | | | LBS/9.3 | |
| | | | | Lutensol | |
| | | | | A3N/9.3 | |

### EXAMPLE 1

### Biological Activity (Shoot Elongation)

Winter oilseed rape (cv. Pronto) was sown in autumn and approximately one month later treated as specified in Table 3. Shoot elongation and root development were assessed a few weeks later. The elongation results are compiled in Table 3.

TABLE 3
Shoot elongation in winter oilseed rape (Scores A1 and A2)

| | | | Stage | | Stage |
|---|---|---|---|---|---|
| | | Stage A1: | A1: plant | Stage A2: | A2: plant |
| Active | | plant | height | plant | height |
| ingredient | [g/ha] | height [cm] | [%] | height [cm] | [%] |
| Control | — | 20 | 100 | 35 | 100 |
| T1 | 428 | 15 | 75 | 19 | 54 |
| | 642 | 15 | 75 | 15 | 43 |
| S1 | 400 | 20 | 100 | 34 | 96 |
| S2 | 600 | 20 | 100 | 34 | 96 |
| S2 | 28 | 16 | 81 | 21 | 61 |
| S2 | 42 | 15 | 75 | 20 | 57 |
| S2 | 84 | 15 | 75 | 16 | 46 |
| F1 | 428 | 15 | 75 | 19 | 54 |
| F1 | 642 | 15 | 75 | 15 | 43 |
| F2 | 428 | 15 | 75 | 16 | 46 |
| F2 | 642 | 14 | 69 | 14 | 39 |
| F3 | 428 | 15 | 75 | 13 | 36 |
| F3 | 642 | 13 | 63 | 10 | 29 |
| F4 | 428 | 15 | 75 | 20 | 57 |
| F4 | 642 | 14 | 69 | 14 | 39 |

The results demonstrate that mepiquat-chloride alone only results in some degree of shortening at scoring date 2. In contrast, the shortening effect of metconazole is very pronounced. However, marked synergistic effects are found for the tank mix of the two active ingredients and for the storage-stable readymixes F1-4 according to the invention. Variant F3, which, in propionic acid and the alkylglucoside, contains two advantageous adjuvants according to the invention, is particularly remarkable.

### EXAMPLE 2

### Homogeneity and Storage Stability

The mixtures F5-7 were storage-stable and monophase over 3 months at a temperature regime of 50° C. While variant F7 was slightly cloudy, it was still homogeneous. The slight cloudiness is caused by the antifoam Silicon SL.

The mixtures F8, F10 and F11 constituted clear homogeneous solutions without crystals present, and revealed no crystalline sediment when used as a 1% strength solution in the tank mix method. In contrast, the mixture F9 was a 2-phase system with a heterogeneous solids content in the liquid phase. It was impossible to prepare a tank mix.

The mixtures F12 to F15 demonstrate that, despite the addition of benzyl alcohol, the absence of the carboxylic acid merely gives 2-phase heterogeneous mixtures which are not applicable.

The active ingredients and adjuvants used in the above examples are explained in Table 4 which follows.

TABLE 4

| Name | Type of structure/material | Manufacturer |
|---|---|---|
| CCC | Chlorcholine chloride, chlormequat- | |
| | chloride | |
| MQC | Mepiquat-chloride | |
| Met | Metconazole | |
| Tebu | Tebuconazole | |
| Epox | Epoxiconazole | |
| Prop | Propionic acid | |
| NOP | N-octylpyrrolidone | |
| NMP | N-methylpyrrolidone | |
| AG6202 | 2-ethylhexylglucoside | Witco |
| Emulgon EL20 | Castor oil × 20 EO | BASF |
| HOE S4212 | Tall oil fatty amine ethoxylate | Clariant |
| Lutensol A3N | C12/14-Fatty alcohol × 3 EO | BASF AG |
| Lutensol A7N | C12/14-Fatty alcohol × 7 EO | BASF AG |
| Lutensol A-LBS | Dodecylbenzenesulfonic acid | BASF AG |
| Lutensol AP10 | Nonylphenol × 10 EO | BASF AG |
| Lutensol ON30 | C9/11-fatty alcohol × 3 EO | BASF AG |
| Lutensol ON70 | C9/11-fatty alcohol × 7 EO | BASF AG |
| Lutensol TO8 | i-C13-Oxo alcohol × 8 EO | BASF AG |
| Rhenalyd WL922 | water-soluble modified linseed | Neste- |
| | oil | Chemicals |
| Rewocid UTM | Undecylenoic acid amidopropyl- | Witco |
| | N-trimethyl-ammonium methosulfate | |
| Silicon SL | Polydimethylsiloxane | Wacker |
| Solvesso 150 | alkylated aromatic hydrocarbon | Exxon |
| Solvesso 200 | alkylated aromatic hydrocarbon | Exxon |
| Wettol EM11 | Calcium alkylarylsulfonate | BASF AG |

1. A composition comprising
(a1) at least one active ingredient selected from among the triazole class or an agriculturally utilizable salt thereof,
(b) at least one straight-chain or branched saturated or unsaturated aliphatic carboxylic acid,
(d) water,
the molar ratio of component (b) to component (a1) being greater than 1, wherein component (a1) amounts to more than 1% by weight and component (d) to more than 10% by weight of the total weight of the composition.

2. A composition as claimed in claim 1, wherein the molar ratio of component (b) to component (a1) is greater than 4.

3. A composition as claimed in claim 1, wherein the carboxylic acid is selected among carboxylic acids of the formula (I)
R³[—CR⁴(R⁵)]ₙ—COOH (I)
where R³, R⁴, R⁵ and n have the following meanings:
R³ is hydrogen, C₁-C₂₅-alkyl, or C₁-C₂₅-alkenyl;
R⁴ is hydrogen, C₁-C₂₅-alkyl, or C₁-C₂₅-alkenyl;
R⁵ is hydrogen, hydroxyl, C₁-C₆-alkoxy or halogen; and
n is 0, 1, 2 or 3, or
R⁴ and R⁵ together with the carbon to which they are bonded form a carbonyl group.

4. A composition as claimed in claim 3, wherein
R³ denotes hydrogen or C₁-C₅-alkyl,
R⁴ denotes hydrogen,
R⁵ denotes hydrogen or hydroxyl, and
n is 1.

5. A composition as claimed in claim 1, wherein the carboxylic acid is selected among propionic acid, lactic acid, oleic acid, acetic acid and glyoxylic acid.

6. A composition as claimed in claim 1, wherein component (b) amounts to more than 2.5% by weight, preferably more than 4% by weight, in particular more than 5% by weight, of the total weight of the composition.

7. A composition as claimed in claim 1 or 6, wherein component (b) amounts to less than 70% by weight, preferably less than 50% by weight, in particular less than 40% by weight, of the total weight of the composition.

8. A composition as claimed in claim 1, wherein the active ingredient of the triazole class is selected among (a11) metconazole, (a12) epoxiconazole, (a13) tebuconazole, (a14) triadimenole, (a15) triadimefone, (a16) cyproconazole (a17) uniconazole, (a18) paclobutrazole and (a19) ipconazole.

9. A composition as claimed in claim 1, wherein component (a1) amounts to more than 2% by weight, in particular more than 2.5% by weight, of the total weight of the composition.

10. A composition as claimed in claim 1 or 9, wherein component (a1) amounts to less than 50% by weight, preferably less than 40% by weight, in particular less than 35% by weight, of the total weight of the composition.

11. A composition as claimed in claim 1, comprising
(a2) at least one active ingredient of the formula (III) 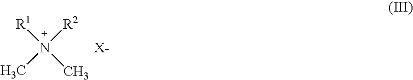
where R¹, R² and X have the following meanings:
R¹ is C₁-C₄-alkyl;
R² is C₁-C₄-alkyl, cyclopentenyl, halogen-C₁-C₆-alkyl, or where R¹ and R² together denote a radical —(CH₂)₅—, —(CH₂)₂—O—(CH₂)₂— or —(CH₂)—CH═CH—(CH₂)—NH—,
X is an anionic group.

12. A composition as claimed in claim 11, wherein the active ingredient of the formula (III) is selected among
(a21) N,N,N-trimethyl-N-β-chloroethyl-ammonium salts of the formula (IIIa) 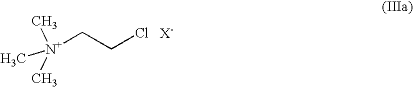
(a22) N,N-dimethylpiperidinium salts of the formula (IIIb) 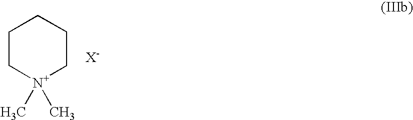
and
(a23) N,N-dimethylmorpholinium salts of the formula (IIIc) 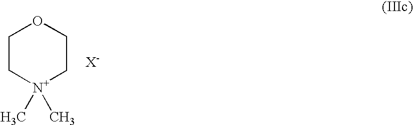
where X⁻ is Cl⁻ or 1/m·[MₓB_{y}O_{z}(A)ᵥ]^{m-}·w (H₂O) where
M is a cation of an agriculturally utilizable metal, hydrogen or ammonium,
B is boron,
O is oxygen,
A is a chelating or complexing group which is associated with at least one boron atom or one agriculturally utilizable cation,
x corresponds to a number 0 to 10,
y corresponds to a number 1 to 48,
v corresponds to a number 0 to 24,
z corresponds to a number 0 to 48,
m corresponds to an integer of 1 to 6, and
w corresponds to an integer 0 to 24.

13. A composition as claimed in claim 1, which is liquid and homogeneous.

14. A composition as claimed in claim 1 comprising
(c) at least one surface-active adjuvant.

15. A composition as claimed in claim 14, wherein component (c) amounts to more than 10% by weight, preferably more than 15% by weight, in particular more than 20% by weight, of the total weight of the composition.

16. A composition as claimed in claim 14 or 15, wherein component (c) amounts to less than 60% by weight, preferably less than 50% by weight, in particular less than 45% by weight, of the total weight of the composition.

17. A composition as claimed in claim 14, wherein the surface-active adjuvant is selected among (c1) alkylglycosides, (c2) alkylsulfonates, alkyl sulfates, alkylarylsulfonates and alkylaryl sulfates, and (c3) quaternized ammonium salts.

18. A composition as claimed in claim 17, wherein component (c1) amounts to more than 2% by weight, preferably more than 10% by weight, in particular more than 5% by weight, of the total weight of the composition

19. A composition as claimed in claim 17 or 18, wherein component (c1) amounts to less than 50% by weight, preferably less than 40% by weight, in particular less than 35% by weight, of the total weight of the composition.

20. A composition as claimed in claim 1, wherein component (d) amounts to more than 20% by weight, in particular more than 25% by weight, of the total weight of the composition.

21. A composition as claimed in claim 1 or 20, wherein component (d) amounts to less than 60% by weight, preferably less than 50% by weight, in particular less than 45% by weight, of the total weight of the composition.

22. A method of bioregulation in plant cultivation which comprises applying to the area under cultivation a composition as claimed in claim 1.

23. The method as claimed in claim 22 in oilseed rape cultivation.

24. The method as claimed in claim 22 for improving root growth.

25. The method as claimed in claim 24, wherein improved root growth manifests itself in an increased number of individual roots, in longer roots and/or in an increased root surface area.

26. The method as claimed in claim 22 for use in the tank mix method.
